(19) United States
(12) Patent Application Publication
(10) Pub. No.: US 2005/0246387 A1
(43) Pub. Date: Nov. 3, 2005

(54) Method and apparatus for managing and manipulating digital files at the file component level

(76) Inventor: Peter S. McChrystal, Indialantic, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 11/101,194

(22) Filed: Apr. 7, 2005

Related U.S. Application Data
(60) Provisional application No. 60/560,330, filed on Apr. 7, 2004.

(51) Int. Cl. G06F 7/00

(52) U.S. Cl. 707/200

(57) ABSTRACT

A document management system that decomposes files into constituent components to permit browsing, searching and retrieving of the components across files. Specific components can be linked into a virtual file so that the selection of one component in the virtual file selects all other components in the file.

This application claims the benefit of U.S. Provisional Patent Application No. 60/560,330 filed on Apr. 7, 2004.

### FIELD OF THE INVENTION

This invention relates generally to documents and their components stored in a document repository or library for use by a plurality of users, and more specifically to a method and apparatus for managing and manipulating document components.

### BACKGROUND OF THE INVENTION

In today's business environment computer users create many different document types, and during any workday each user creates many such documents. Document types, which are typically stored in the form of files, include text files, presentation files, database files and spreadsheets files. These document types can be further classified into two categories, structured and unstructured. The structured category includes information that is created and maintained in a rigorously defined arrangement, such as a database. Unstructured includes most of the remaining document types, e.g. text files, presentation files, spreadsheets, etc. The great majority of digital information is in the unstructured form.

In a business enterprise, the documents can be stored locally on an individual user's computer storage media (such as a hard disc drive) or stored on one or more file servers accessible to all users. The documents stored on the file servers are revised by the author or another contributor and others with access to the stored document files can generate derivative documents (files) using components (paragraphs, pages, charts, slides, etc.) copied from the original (source) document file. For example, a controller consults the spreadsheet prepared by an accounting manager to create a financial report for senior management. An engineer relies on a component price set forth in a database document prepared by a buyer, for use in preparing a customer proposal. It is a document's content components (e.g., individual facts, ideas, charts, pictures, conclusions, etc., within the document), and not the document as a whole, that are continually reused in new combinations to form derivative documents for other business purposes. Although only the document content components i.e., unstructured business information, are needed and used by others, the components are stored and accessed as document files.

To generate the derivative document, the stored source file is copied from the server to the user's computer, desired components are selected from the document and copied into the derivative file created by the user. Typically, the user copies the entire original document and extracts the desired components therefrom, unless the user has advance knowledge of the original document contents, in which case the user can locate and copy only those components.

Although widespread availability and use of these documents' content is crucial to the organization' mission, it is recognized that modification of a source document will not be captured by a derivative document prepared prior to the modification. Thus, before a user can finalize his document, he must check the source document one last time to ensure that it has not been modified. Known techniques for document management and use operate at the file level, limiting the user's capability to manage information below the file level.

### BRIEF SUMMARY OF THE INVENTION

According to one embodiment, the present invention comprises a method for managing information within a source file. The method further comprises importing the source file to a file repository, decomposing the source file into one or more components; and processing the components of the source file independent from processing the source file.

According to another embodiment, the invention comprises a file library repository, further comprising source files, wherein each source file further comprises a plurality of file components, an engine for decomposing each source file into file components and associating the file components with the source file from which the file components were decomposed and the engine for permitting a user to search the file components and to retrieve desired file components without retrieving the source file from which the relevant file components were decomposed.

### BRIEF DESCRIPTION OF THE DRAWINGS

The present invention can be more easily understood and the further advantages and uses thereof more readily apparent, when considered in view of the following detailed description when read in conjunction with the following figures, wherein:

FIG. 1 illustrates operation of the present invention in schematic block diagram form.

FIG. 2 is a flowchart illustrating steps for carrying out the teachings of the present invention.

In accordance with common practice, the various detailed features are not drawn to scale, but are drawn to emphasize specific features relevant to the invention. Like reference characters denote like elements throughout the figures and text.

### DETAILED DESCRIPTION OF THE INVENTION

Before describing in detail the particular method and apparatus for managing and manipulating documents below the file level in accordance with the present invention, it should be observed that the present invention resides primarily in a novel combination of hardware and software elements. Accordingly, so as not to obscure the disclosure with details that will be readily apparent to those skilled in the art having the benefit of the description herein. In the description that follows, certain hardware and software elements have been described with lesser detail, while the drawings and specification describe in greater detail other elements and steps pertinent to understanding the invention. The following embodiments are not intended to define limits as to the structure or use of the invention, but only to provide exemplary constructions. The embodiments are permissive rather than mandatory and illustrative rather than exhaustive.

The present invention enables the import and decomposition of digital documents into document components, management of these documents and components, creation of new documents from components, formation of relationships between these components, and distribution and sharing of these components and documents within the context of a digital library repository. One differentiating factor of the present invention includes the ability to accept common digital documents, decompose these documents into components, and then use the components to create new documents or relationships between components, whereas known document management systems manage each document as a single atomic entity.

For certain central (i.e., accessible to a plurality of users) content (file or document) repositories (central file server), an operating system or a dedicated file-based document management system provides file management capabilities. The repository is sometimes referred to as a “digital library” because it comprises a collection of digital files in an organized file structure. It is known that a prior art digital library or digital library system can provide added value for each digital file stored in the library. Examples include the capability to view document and document page thumbnails, to search document contents and return documents satisfying the search criteria and to add metadata to the documents. In short, the digital library and its controlling software take the management of digital files to a higher level of utility. In most applications, the library is further optimized to serve a specific business process (i.e. support a sales team with digital sales literature and materials or provide engineering with a searchable repository of architectural drawings).

The document management system of the present invention permits management of unstructured information within documents and files at a document or file component level, i.e., objects within the document or the file, such as phrases within documents or individual slides or charts within presentations. The user can browse, search, retrieve and repurpose information at the file component level, including directly accessing and retrieving slides, pages, paragraphs, charts, etc. The user creates new documents (derivative documents) including file components that are selected and retrieved from the documents stored in the digital library (source documents).

According to another embodiment of the present invention, a document creator or document administrator can control specific file components. For example, users may be prohibited from editing file components, but may be permitted to copy those components to create the derivative document.

The present invention also teaches the capability to form relationships between predetermined file components. That is, certain file components can be linked into a group for a specified purpose. The selected components are assigned to a virtual informational unit such that when a user selects one component from the virtual informational unit, all linked components are included within the selected group, thereby requiring the user to select the entire group. This feature ensures the integrity of the information presented in the derivative document. For example, a finance document comprises a plurality of file components, including for example charts, text, tabular entries and a mandatory document disclaimer. By linking the file components with the mandatory disclaimer, when a user extracts one or more file components, she also receives the mandatory disclaimer linked to those components. In this way the systems ensures that the disclaimer appears with the extracted components when presented in the derivative document.

The document management system of the present invention enables a user to construct new files (i.e., derivative documents) from existing file components by selecting desired file components from existing documents. The file components can also be browsed and searched prior to selecting components for retrieval. By way of example, and not limitation, a search process returns the following exemplary file components: portable document format (.pdf) pages in a file, individual slides of a PowerPoint presentation, charts included within a document file, and a Microsoft Word page or paragraph.

According to the teachings of the present invention, information files stored in the repository are decomposed into individual components or sub-files. Components can include individual slides from a multi-slide presentation document, pages or paragraphs from a text document and objects (e.g., charts, tables) and files embedded in a document. Preferably, the digital library system (also referred to as a librarian) stores a plurality of information elements (metadata or tags) about each information file and its components to provide the capabilities offered by the present invention.

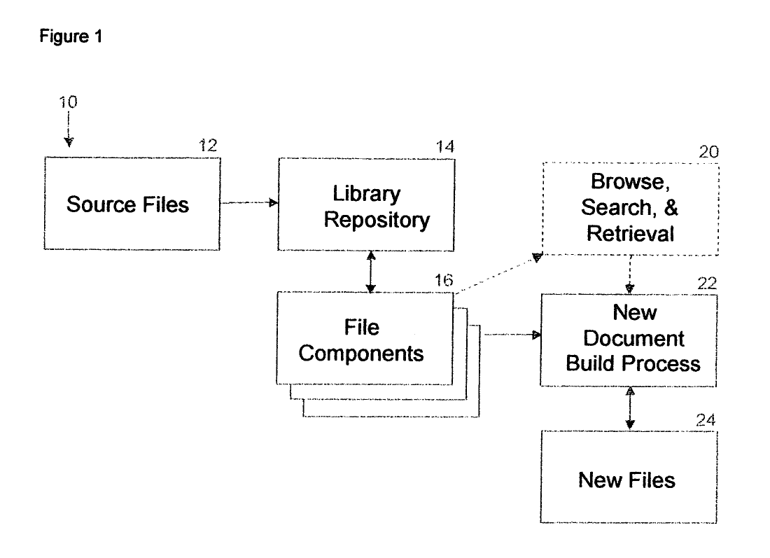

FIG. 1 schematically illustrates a document management system 10 according to the teachings of the present invention. When source files 12 are imported into a library repository 14, each source file is decomposed into file components 16. A system of the present invention tracks the file components 16 stored in the library repository 14 as individual objects, thereby allowing viewing and searching at the object level. Tracking the individual objects also permits establishing relationships or links between objects such that when a user selects an object all linked objects are also provided. As indicated by a block 20, a user can browse and search the file components across all files in the repository 14 and retrieve selected file components. As indicated by a block 22, a new or derivative file or document 24 is built from the selected file components. Typically, the new files or documents 24 comprise file components retrieved from files stored in the library repository 14 and new document elements created by the user.

The teachings of the present invention can be applied to any document format, including, but not limited to, documents prepared using Microsoft's Office® suite of applications (e.g., Excel, Word, PowerPoint, and Access), Adobe® portable document format, Adobe® Framemaker, Adobe® InDesign, Quark Express, Microsoft Project and Microsoft Visio or other known rich-media document formats.

According to a preferred embodiment, the document management engine is embodied as a plug-in to a computer operating system and/or to known applications running under that operating system. In another embodiment the engine operates as a standalone application running on an individual user's computer or on a collectively accessed server in either a client-server or web-based configuration.

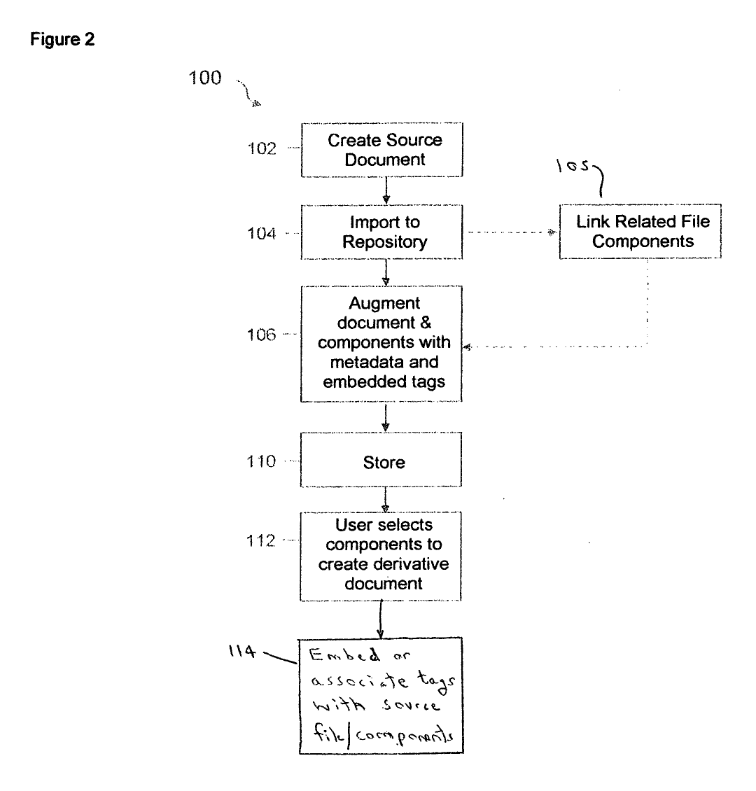

FIG. 2 is a flow chart 100 depicting the steps associated with a preferred embodiment of the present invention. In one embodiment, the FIG. 2 method is implemented in a microprocessor and associated memory elements within a client computer and/or within a central repository. In such an embodiment the FIG. 2 steps represent a program stored in the memory element and operable in the microprocessor. When implemented in a microprocessor, program code configures the microprocessor to create logical and arithmetic operations to process the flow chart steps. The invention may also be embodied in the form of computer program code written in any of the known computer languages containing instructions embodied in tangible media such as floppy diskettes, CD-ROM's, hard drives, DVD's, removable media or any other computer-readable storage medium. When the program code is loaded into and executed by a general purpose or a special purpose computer, the computer becomes an apparatus for practicing the invention. The invention can also be embodied in the form of a computer program code, for example, whether stored in a storage medium loaded into and/or executed by a computer or transmitted over a transmission medium, such as over electrical wiring or cabling, through fiber optics, or via electromagnetic radiation, wherein when the computer program code is loaded into and executed by a computer, the computer becomes an apparatus for practicing the invention.

The FIG. 2 flow chart 100 begins at a step 102 where a source document is created and imported to the library repository 14 at a step 104. When the source file 12 and its components 16 are imported into the repository 14, the file 12 and the file components 16 (objects) are parsed (decomposed) and encrypted (in one embodiment). Also, characters/code strings (referred to as tags or metadata) are created to represent various attributes of the document/file and its components, including: properties, text, page objects, layout and background. See a step 106. This list is merely exemplary and can be augmented with additional file and component attributes as desired. Copies of the metadata are embedded within or stored and associated with the source file 12 and the file's components 16, as well as in the repository 14, as indicated by a step 110. In one embodiment the metadata is encrypted.

As depicted at a step 112, a user selects source document/components 12/16 from the library repository 14 to a local computer storage device to create the derivative document/components 24 based thereon. As indicated at a step 114, the tags associated with the source file/components 12 are embedded in or stored locally and associated with the derivative file/components 24.

According to another embodiment of the present invention, at a step 105, related components are linked into a virtual file or information unit. Later at the step 112, when the user selects one or more file components, all components linked with a selected file component are also automatically selected.

Although the teachings of the present invention have been described with respect to derivative documents and derivative document components stored locally, i.e., on a user's local computer, for example, the present invention is not so limited. The derivative documents and derivative document components may be stored on a shared network drive or another public data storage device.

Additionally, once the derivative document is created from file components retrieved from the repository library, in the event one of the file components stored in the library is modified, for example by the file author, the modification is propagated to the file components within the derivative documents. This invention is described and claimed in the commonly owned patent application assigned application Ser. No. 11/061,093, filed on Feb. 19, 2005, and entitled “Method and Apparatus for Automatic Update and Notification of Documents and Document Components Stored in a Document Repository”.

Further details of the document management system using a PowerPoint® file as an example, is described. When a PowerPoint file is imported into the library repository 14, a set of three hashes, in one embodiment is calculated for every slide in the presentation. The set of three hashes is also referred to as a triple hash. Each hash corresponds to structure, text and format specifiers of its associated slide. The triple hash enables the document management system of the present invention to identify slides (file components) and use them in the construction of a new document. The hashes also permit linking of certain file components. These hashes also permit linking of file components. The slide is also tagged with metadata that assists the document manager in identifying certain elements of the slide during browse and search operations. The slide tag essentially consists of accountID, account name, libraryID, library name, fileID, file name and the triple-hash. Although the account name, library name and file name may be redundant, these identifiers are attached to the slide to enable other search features that provide information about the slide, without consulting the metadata stored in the repository 14. According to one embodiment, the tag is stored as a comment on the notes page of every slide. This location was selected because the comments on the notes page cannot be accessed through any interface with the PowerPoint® application, but can be accessed only programmatically. The tag is also stored in the repository 14. Components of files created using other software programs are similarly tagged for processing, with the tags embedded in or associated with each file component.

While the invention has been described with reference to preferred embodiments, it will be understood by those skilled in the art that various changes may be made and equivalent elements may be substituted for elements thereof without departing from the scope of the invention. The scope of the present invention further includes any combination of the elements from the various embodiments set forth herein. In addition, modifications may be made to adapt a particular situation to the teachings of the present invention without departing from its essential scope. Therefore, it is intended that the invention not be limited to the particular embodiment disclosed as the best mode contemplated for carrying out this invention, but that the invention will include all embodiments falling within the scope of the appended claims.

1. A method for managing information within a source file, comprising:
importing the source file to a file repository;
decomposing the source file into one or more components; and
processing the components of the source file independent from processing the source file.

2. The method of claim 1 further comprising a step of browsing the components in response to user-initiated inquiries.

3. The method of claim 1 further comprising a step of searching the components in response to user-initiated inquiries.

4. The method of claim 1 further comprising a step of retrieving desired components from one or more source files.

5. The method of claim 4 further comprising a step of creating a new file using retrieved components.

6. The method of claim 5 further comprising:
storing the new file including the retrieved components to a storage element;
modifying a source file, including modifying one or more of the components within the source file to create one or more modified components; and
propagating the one or more modified components to the new file to update the retrieved components according to modifications of the one or more modified components.

7. The method of claim 1 further comprising a step of linking predetermined components such that the step of processing the components further comprises processing all linked components.

8. The method of claim 7 wherein the linked components comprise components in a single file.

9. The method of claim 7 wherein the linked components comprise linked components from a plurality of files.

10. The method of claim 1 wherein the step of identifying components of each source file further comprises decomposing each source file into file components.

11. The method of claim 1 further comprising storing information elements representing predetermined characteristics of the components.

12. The method of claim 11 further comprising storing the information elements representing a component with the component.

13. The method of claim 11 further comprising storing the information elements separate from the component and associating the information elements with the component.

14. A computer program product for managing information within a file, the computer program comprising:
a computer usable medium having computer readable program code modules embodied in the medium for managing the information;
a computer readable first program code module for importing the source file;
a computer readable second program code module for decomposing the source file into one or more components; and
a computer readable third program code module for processing the components of a source file independent from processing the source file.

15. The computer program product of claim 14 further comprising a computer readable fourth program code module for linking related components into a linked component group and a fifth program code module for retrieving components in response to a user's request, wherein when the fifth program code module retrieves one component in the linked component group, all components in the linked group are retrieved.

16. A file library repository, comprising:
source files, wherein each source file further comprises a plurality of file components;
an engine for decomposing each source file into file components and associating the file components with the source file from which the file components were decomposed; and
the engine for permitting a user to search the file components and to retrieve desired file components without retrieving the source file from which the relevant file components were decomposed.

17. The file library repository of claim 16 wherein the engine further creates a component tag for each component and associates the component tag with the component to which the component tag relates.
